(19) United States
(12) Patent Application Publication
(10) Pub. No.: US 2006/0154173 A1
(43) Pub. Date: Jul. 13, 2006

(54) Resist composition

(76) Inventors: Satoru K.K Ishigaki, Kanagawa (JP); Kunio Matsuki, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/563,485

(22) PCT Filed: Jul. 6, 2004
(86) PCT No.: PCT/JP04/09980

§ 371 Date: Jan. 5, 2006

Related U.S. Application Data
(60) Provisional application No. 60/489,493, filed on Jul. 24, 2003.

(30) Foreign Application Priority Data
Jul. 8, 2003 (JP) 2003-193831

(51) Int. Cl. G03C 1/76

(52) U.S. Cl. 430/270.1

(57) ABSTRACT

There is provided a resist composition used for the production of printed boards, which comprises (A) a resin component, (B) a photopolymerization initiator, (C) water and (D) an organic solvent, wherein the organic solvent (D) contains: (D-1) at least one organic solvent selected from the group consisting of an α-hydroxycarboxylate ester, a β-alkoxycarboxylate ester, a 1,3-diol compound and a 1,3-diol compound derivative, and (D-2) an organic solvent having a hydroxyl group other than (D-1).

### CROSS-REFERENCES TO RELATED APPLICATIONS

This application claims benefit under 35 U.S.C. §119(e) to U.S. Provisional Application Ser. No. 60/489,493, filed Jul. 24, 2003.

### TECHNICAL FIELD

The present invention relates to a resist composition used for the production of printed boards and, more particularly, to a water-based solution or dispersion type resist composition, and a method of producing a resist-coated substrate using the same.

### BACKGROUND ART

A printed circuit board has hitherto been produced by forming a resist coating film on an insulating substrate comprising a conductive metal layer such as copper foil (which may contain metal other than copper, hereinafter referred merely to a “copper-clad substrate”), exposing to light through a photomask having a prescribed pattern, developing with water or alkali water, etching the conductive metal layer at the portion where no resist is remained with an etching solution, and removing the resist to form a prescribed wiring pattern.

Examples of the method of forming a resist layer on a copper-clad substrate include a dry film method and a liquid resist coating method. In the liquid resist coating method, a dip coating method is known, in addition to a method of coating a liquid resist on a copper-clad substrate by means of roll coating or screen printing. This method comprises dipping a copper-clad substrate in a large amount of a resist composition solution (commonly in the form of a solution), pulling up the copper-clad substrate, and drying it thereby to vaporize the solvent, thus forming a resist coating film on the copper-clad substrate.

A high volatile organic solvent has conventionally been used as a solvent in a liquid resist composition to be used in a dip coating method. Under the apprehension of an adverse influence on the human body and environment, a resist composition containing water as a solvent disclosed in Japanese Unexamined Patent Publication (Kokai) No. 53-97416 has recently been proposed.

When applying the resist composition containing water to the dip coating method, there arises a problem that copper ions eluted from a copper plate accumulate in a resist solution thereby to cause ion crosslinking. In the dip coating method, the operation of dipping a copper-clad substrate in large excess of a resist solution for a given time and pulling up the copper-clad substrate is performed, and metal ions such as copper ions are eluted during the dipping operation. During the dipping operation, considerable portion of the resist solution in contact with the substrate is remained in the resist solution. In case of the production on a large scale, this resist solution is repeatedly used, and thus metal ions such as copper ions gradually accumulate in the resist solution. As a result, crosslinking of resist components is caused by metal ions such as copper ions, resulting in an increase in viscosity of the resist solution and, in worse case, precipitates and aggregates are formed. This arise problems, for example, change in thickness of the coating film, formation of foreign matters on the coated substrate and the like. The former can be solved by adjusting the coating conditions, while the latter is hardly avoided.

Severe problem such as accumulation of metal ions into the resist solution arises in the dip coating method, and may also arise in other resist layer forming methods such as liquid resist coating method.

In order to suppress crosslinking due to metal ions such as copper ions eluted from the copper-clad substrate, the addition of a chelating agent in a water-based electrodeposition coating composition is proposed in Japanese Examined Patent Publication (Kokoku) No. 6-44150. However, the compound disclosed in the patent document has a problem that it exerts insufficient effect and deteriorates sensitivity to ultraviolet light.

An object of the present invention is to improve storage stability of a solution or dispersion type resist composition containing water as a solvent during a repeating dip coating operation while maintaining sensitivity of the resist composition.

Under these circumstances, the present inventors have intensively studied and found that the object described above can be achieved by using a specific compound and a specific organic solvent in combination in a water-containing resist composition for dip coating, and thus the present invention have been completed. The present invention is directed to [1] to [8] described below.

### SUMMARY OF THE INVENTION

[1] A resist composition comprising (A) a resin component, (B) a photopolymerization initiator, (C) water and (D) an organic solvent, wherein the organic solvent (D) contains:

(D-1) at least one organic solvent selected from the group consisting of an α-hydroxycarboxylate ester, a β-alkoxycarboxylate ester, a 1,3-diol compound and a 1,3-diol compound derivative, and

(D-2) an organic solvent having a hydroxyl group other than (D-1).

[2] The resist composition according to [1], wherein (D-1) is an α-hydroxycarboxylate ester.

[3] The resist composition according to [2], wherein the α-hydroxycarboxylate ester is a lactate ester.

[4] A method of producing a resist-coated substrate, which comprises dipping an insulating substrate comprising a conductive metal in the resist composition according to any one of [1] to [3].

[5] A method of producing a print circuit board, which comprises using the resist composition according to any one of [1] to [3].

[6] A resist composition for dip coating comprising (A) a resin component, (B) a photopolymerization initiator, (C) water and (D) an organic solvent, wherein the organic solvent (D) contains:

(D-1) at least one organic solvent selected from the group consisting of an α-hydroxycarboxylate ester, a β-alkoxycarboxylate ester, a 1,3-diol compound and a 1,3-diol compound derivative.

[7] A method of producing a resist-coated substrate, which comprises dipping an insulating substrate comprising a conductive metal in the resist composition according, to [6].

[8] A method of producing a print circuit board, which comprises using the resist composition according to [6].

### DETAILED DESCRIPTION OF THE INVENTION

The present invention will now be described in detail.

(A) Resin Component

The resin component (A) used in the resist composition of the present invention is soluble in a developer and is slightly soluble in an etching solution, and is preferably a component containing a resin having a carboxyl group or an anhydride group thereof in the molecule. Examples of the resin having a carboxyl group or an anhydride group thereof in the molecule include an acrylic resin, which is a copolymer containing (meth)acrylic acid and (meth)acrylate as a monomer, a copolymer of (meth)acrylic acid and ethylene, and a copolymer of maleic anhydride and ethylene or styrene, and the acrylic resin is particularly preferable in view of adhesion and tack.

The (meth)acrylic acid means methacrylic acid and/or acrylic acid.

The resin component (A) is preferably a photopolymerizable resin which can cause photopolymerization by means of irradiation with ultraviolet light, X-ray or electron beam in the presence or absence of a photopolymerization initiator, and examples thereof include those having a plurality of polymerizable groups such as ethylenically unsaturated bonds in the molecule.

As the photopolymerizable resin, publicly known photopolymerizable resins can be used alone or in combination and, for example, it can be selected from the following groups (1) to (5).

(1) a reaction product of an unsaturated hydroxyl compound, and a resin having at least one functional group selected from the group consisting of a carboxyl group, a carboxylic anhydride group, an isocyanate group and an epoxy group;

(2) a reaction product of an unsaturated epoxy compound, and a resin having at least one functional group selected from the group consisting of a carboxyl group, a carboxylic anhydride group, an isocyanate group, an amino group and a hydroxyl group;

(3) a reaction product of an unsaturated carboxylic acid or an unsaturated carboxylic anhydride, and a resin having at least one functional group selected from the group consisting of a hydroxyl group, an amino group, an isocyanate group and an epoxy group;

(4) a reaction product of an unsaturated amino compound, and a resin having at least one functional group selected from the group consisting of a carboxyl group, a carboxylic anhydride group, a formyl group, a keto group, an isocyanate group and an epoxy-group; and

(5) a reaction product of an unsaturated isocyanate compound, and a resin having at least one functional group selected from the group consisting of a carboxyl group, a carboxylic anhydride group, an amino group, a hydroxyl group and an epoxy group.

While the weight-average molecular weight and acid value (mgKOH/g) of these photopolymerizable resins are not specifically limited, the weight-average molecular weight is preferably within a range from 500 to 100,000, more preferably from 1,000 to 50,000, and most preferably from 2,000 to 20,000, and the acid value is preferably within a range from 20 to 350, more preferably from 50 to 250, and most preferably from 80 to 200.

The weight-average molecular weight is measured by gel permeation chromatography and the acid value is measured by the procedure defined in JIS K5601.

Specific examples of the unsaturated hydroxyl compound include 2-hydroxyethyl (meth)acrylate, 2-hydroxypropyl (meth)acrylate, polyethylene glycol mono(meth)acrylate (e.g. diethylene glycol monoacrylate), polyethylene glycol mono(meth)acrylate (e.g. triethylene glycol mono(meth)acrylate), 1,4-butanediol mono(meth)acrylate, ethylene glycol mono(meth)allyl ether, polyethylene glycol mono(meth)allyl ether (e.g. diethylene glycol mono(meth)allyl ether), N-methylolacrylamide, allyl alcohol, methallyl alcohol, hydroxystyrene, hydroxymethylstyrene, and allyl phenol.

Specific examples of the unsaturated epoxy compound include glycidyl (meth)acrylate, allyl glycidyl ether, and 3,4-epoxycyclohexylmethyl (meth)acrylate.

As the unsaturated carboxylic acid and anhydride thereof, for example, there can be used (meth)acrylic acid, crotonic acid, itaconic acid, maleic acid, fumaric acid, sorbic acid, tetrahydrophthalic acid, cinnamic acid, nadic acid, oleic acid, linoleic acid, linolenic acid, eleostearic acid, licanoic acid, ricinoleic acid, arachidonic acid, and anhydrides thereof.

Examples of the unsaturated amino compound include allylamine, diallylamine, aminostyrene, aminomethylstyrene, acrylamide, and a reaction product of an unsaturated carboxylic acid or a derivative thereof and polyamine such as ethylenediamine.

As the unsaturated isocyanate compound, for example, there can be used 2-isocyanate ethyl (meth)acrylate, allyl isocyanate, and a reaction product of an unsaturated hydroxyl compound and polyisocyanate such as tolylene diisocyanate or xylylene diisocyanate.

The resin having at least one functional group used in (1) to (5) is at least one homopolymer or copolymer selected from among the above-mentioned unsaturated carboxylic acid, unsaturated carboxylic anhydride, unsaturated isocyanate compound, unsaturated epoxy compound, unsaturated hydroxy compound and unsaturated amino compound.

Examples of the resin having a carboxyl group as a functional group include poly(meth)acrylic acid, a (meth)acrylic acid-methyl (meth)acrylate copolymer, a (meth)acrylic acid-styrene copolymer, a styrene-maleic anhydride copolymer, an ethylene-(meth)acrylic acid copolymer, terminal carboxylated polybutadiene, a terminal carboxylated butadiene-acrylonitrile copolymer, and an (anhydrous) polyhydric carboxylic acid adduct of a phenol resin.

Examples of the resin having a hydroxyl group include polyhydroxyethyl (meth)acrylate, a hydroxyethyl (meth)acrylate-styrene copolymer, a hydroxyethyl (meth)acrylate-methyl methacrylate copolymer, a novolak type phenol resin, polyvinyl alcohol, a partially saponified ethylene-vinyl acetate copolymer, polyglycerin, polyvinyl phenol, a carboxylic acid adduct of an epoxy resin, polyethylene glycol, polypropylene glycol, terminal hydroxylated (hydrogenated) polybutadiene, terminal hydroxylated (hydrogenated) petroleum resin, and a reaction product of polyhydric alcohol and polyhydric isocyanate.

Examples of the resin having an epoxy group include polyglycidyl (meth)acrylate, a glycidyl (meth)acrylate-styrene copolymer, a glycidyl (meth)acrylate-methyl methacrylate copolymer, a reaction product of a novolak type phenol resin and epichlorohydrin, a reaction product of polyhydric phenol and epichlorohydrin, and a reaction product of polyhydric alcohol and epichlorohydrin.

Examples of the resin having an amino group include polyacrylamide, polyallylamine, saponified polyvinyl formamide, saponified polyvinyacetamide, polyaminostyrene, an aminostyrene-styrene copolymer, a reaction product of a carboxyl group-containing resin and polyvalent amine, an urea resin, and a melamine resin.

Examples of the resin having an isocyanate group include poly-2-isocyanate ethyl (meth)acrylate, a 2-isocyanate ethyl (meth)acrylate-methyl (meth)acrylate copolymer, and a reaction product of a polyhydric isocyanate compound and a polyhydric hydroxyl compound.

More specifically, preferable examples of (1) to (5) include:

(1-1) a reaction product of an unsaturated hydroxyl compound and a resin having a carboxylic anhydride group, for example, a reaction product of hydroxyethyl acrylate and a styrene-maleic anhydride copolymer, and those obtained by further reacting these reaction products with a base;

(1-2) a reaction product of an unsaturated hydroxyl compound and a resin having an isocyanate group;

(2-1) a reaction product of an unsaturated epoxy compound and a resin having a carboxyl group, for example, a reaction product of glycidyl acrylate and a methacrylic acid-methyl methacrylate copolymer, a reaction product of 3,4-epoxy-cyclohexylmethyl acrylate and a methacrylic acid-methyl methacrylate copolymer, and those obtained by further reacting these reaction products with a base; and

(3-1) a reaction product of an unsaturated carboxylic acid or an unsaturated carboxylic anhydride and a resin having an epoxy group, for example, a reaction product of acrylic acid and polyglycidyl methacrylate, and a reaction product of acrylic acid and a glycidyl methacrylate methyl methacrylate copolymer.

Among these reaction products, an acrylic resin composed of a copolymer of (meth)acrylic acid and an ester thereof, or a modified product thereof are particularly preferable, and specific examples thereof include a reaction product of glycidyl acrylate and a methacrylic acid-methyl methacrylate copolymer, a reaction product of 3,4-epoxy-cyclohexylmethyl acrylate and a methacrylic acid-methyl methacrylate copolymer, and those obtained by further reacting these reaction products with a base.

Examples of the photopolymerizable resin which can be used, in addition to (1) to (5), include:

(6) a homopolymer or copolymer of a conjugated diene compound and a modified product thereof, for example, polybutadiene;

(7) a polymerizable unsaturated resin obtained by adding an unsaturated dicarboxylic acid or an anhydride thereof to an unsaturated bond in a fatty acid chain in an esterified product of an epoxy resin and an unsaturated fatty acid;

(8) a polymerizable unsaturated resin composed of an unsaturated fatty acid-modified high acid value alkyd resin; and

(9) a mixture of a polymerizable unsaturated resin composed of maleinated oil and an ethylenically unsaturated compound having one or more polymerizable unsaturated bonds in a molecule.

(B) Photopolymerization Initiator

As the photopolymerization initiator (B), for example, publicly known photopolymerization initiators can be used. Specific examples thereof include benzoin, benzoin methyl ether, benzoin ethyl ether, benzyl, diphenyl disulfide, tetramethylthiuram sulfide, diacetyl, eosin, thionine, Michlers' ketone, anthraquinone, chloroanthraquinone, methylanthraquinone, α-hydroxyisobutylphenone, p-isopropyl-α-hydroxyisobutylphenone, α,α′-dichloro-4-phenoxyacetophenone, 1-hydroxy-1-cyclohexylacetophenone, 2,2-dimethoxy-2-phenylacetophenone, methylbenzoyl formate, 2-methyl-1-[4-(methylthio)phenyl]-2-morpholinopropan-1-one, benzophenone, thioxanthone, 2-chlorothioxanthone, 2,4-diethylthioxanthone, 2-isopropylthioxanthone, 4-benzoyl-4′-methyldiphenyl sulfide, ethyl N,N-dimethylaminobenzoate, pentyl N,N-dimethylaminobenzoate, and triethanolamine. These photopolymerization initiators may be used alone, but are preferably used in combination.

The content of these photopolymerization initiators is within a range from 0.01 to 20% by weight, preferably from 0.1 to 15% by weight, and most preferably from 0.5 to 10% by weight, based on the total weight (containing the solvent) of the resist composition of the present invention. When the content of the photopolymerization initiator (B) is less than 0.01% by weight, photopolymerization does not proceeds sufficiently, and thus making it difficult to maintain performances as the resist. On the other hand, when the content exceeds 20% by weight, storage stability and properties of the coating film may deteriorate.

(C) Water

The resist composition of the present invention contains water (C) as the solvent. Since the resist composition contains water (C), it is made possible to decrease the amount of a high volatile organic solvent and to increase a flash point of the resist composition and to improve safety during storage and transportation. The content of water (C) in the resist composition of the present invention is within a range from 5 to 80% by weight, preferably from 10 to 75% by weight, more preferably from 20 to 70% by weight, still more preferably from 25 to 65% by weight, and most preferably from 30 to 60% by weight, based on the resist composition.

(D) Organic Solvent

The organic solvent (D) of the present invention contains at least one organic solvent (D-1) selected from the group consisting of an α-hydroxycarboxylate ester, a β-alkoxycarboxylate ester, a 1,3-diol compound and a 1,3-diol compound derivative, and a hydroxyl group-containing organic solvent (D-2) other than the organic solvent (D-1).

(D-1)

The organic solvent (D-1) is selected from the group consisting of an α-hydroxycarboxylate ester, a β-alkoxycarboxylate ester, a 1,3-diol compound and a 1,3-diol compound derivative, and these compounds may be used alone or in combination. The content of the organic solvent (D-1) is within a range from 0.1 to 40% by weight, preferably 0.5 to 30% by weight, more preferably from 1.0 to 20% by weight, and most preferably from 1.0 to 15% by weight, based on the resist composition of the present invention. When the content of the organic solvent (D-1) is less than 0.1% by weight, the effect of the present invention is not recognized. On the other hand, even if the organic solvent (D-1) is added in the amount of more than 40% by weight, an additional effect can not be expected.

Among the organic solvent (D-1) in the present invention, the α-hydroxycarboxylate ester is not specifically limited and publicly known esters can be used. Specific examples of the α-hydroxycarboxylate ester include glycolate esters such as methyl glycolate, ethyl glycolate, n-propyl glycolate, isopropyl glycolate, n-butyl glycolate, isobutyl glycolate, n-pentyl glycolate, n-hexyl glycolate, and cyclohexyl glycolate; lactate esters such as methyl lactate, ethyl lactate, n-propyl lactate, isopropyl lactate, n-butyl lactate, isobutyl lactate, amyl lactate, isoamyl lactate, n-hexyl lactate, cyclohexyl lactate, and benzyl lactate; α-hydroxybutyrate esters such as methyl α-hydroxybutyrate, ethyl α-hydroxybutyrate, n-propyl α-hydroxybutyrate, isopropyl α-hydroxybutyrate, n-butyl α-hydroxybutyrate, isobutyl α-hydroxybutyrate, n-pentyl α-hydroxybutyrate, n-hexyl α-hydroxybutyrate, and cyclohexyl α-hydroxybutyrate; and α-hydroxyvalerate esters such as methyl α-hydroxyvalerate, ethyl α-hydroxyvalerate, n-propyl α-hydroxyvalerate, isopropyl α-hydroxyvalerate, n-butyl α-hydroxyvalerate, isobutyl α-hydroxyvalerate, amyl α-hydroxyvalerate, n-hexyl α-hydroxyvalerate, and cyclohexyl α-hydroxyvalerate.

Among the organic solvent (D-1) in the present invention, the β-alkoxycarboxylate ester is not specifically limited and publicly known esters can be used. Specific examples of the β-alkoxycarboxylate ester include methyl 3-methoxy-propionate, ethyl 3-methoxy-propionate, methyl 3-methoxy-butyrate, ethyl 3-methoxy-butyrate, methyl 3-methyl-3-methoxy-butyrate, ethyl 3-methyl-3-methoxy-butyrate, methyl 2-methoxy-cyclohexane-carboxylate, and those wherein a methoxy group is replaced by the other alkoxy group such as ethoxy group.

Among the organic solvent (D-1) in the present invention, the 1,3-diol compound is not specifically limited and publicly known compounds having a 1,3-diol structure can be used. Also it may have the other functional group other than the diol structure, for example, hydroxyl group. Specific examples of the 1,3-diol compound include 1,3-propanediol, 1,3-butanediol, 2-methyl-1,3-propanediol, 2,2-dimethyl-1,3-propanediol, 2-methyl-1,3-butanediol, 3-methyl-1,3-butanediol, 1,3-pentanediol, 2,4-pentanediol, 1,3-hexanediol, 2,4-hexanediol, trimethylolpropane, and pentaerythritol.

Among the organic solvent (D-1) in the present invention, the 1,3-diol compound derivative is a compound having such a structure that at least one hydroxyl group among two hydroxyl groups of a 1,3-diol structure is etherified or esterified, and publicly known compounds can be used without any limitation. Specific examples of the 1,3-diol compound derivative include 3-methoxy-1-propanol, 2-methyl-3-methoxy-1-propanol, 2,2-dimethyl-3-methoxy-1-propanol, 3-methoxy-1-butanol, 3-methoxy-3-methyl-1-butanol, and those wherein a methoxy group is replaced by an ethoxy group or the other alkoxy group; 3-acetoxy-1-propanol, 2-methyl-3-acetoxy-1-propanol, 2,2-dimethyl-3-acetoxy-1-propanol, 3-acetoxy-1-butanol, 3-acetoxy-3-methyl-1-butanol, and those wherein an acetoxy group is replaced by the other acyloxy group; and 3-methoxy-1-propyl acetate, 2-methyl-3-methoxy-1-propyl acetate, 2,2-dimethyl-3-methoxy-1-propyl acetate, 3-methoxy-1-butyl acetate, 3-methoxy-3-methyl-1-butyl acetate, those wherein a methoxy group is replaced by an ethoxy group or the other alkoxy group, and those wherein an acetoxy group is replaced by the other acyloxy group.

In order to increase the flash point of the resist composition of the present invention and to improve safety during storage and transportation, the flash point of the organic solvent (D-1) is commonly 40° C. or higher, preferably within a range from 45 to 120° C., and more preferably from 50 to 110° C.

The organic solvent (D-2) of the present invention, namely a hydroxyl group-containing organic solvent other than the organic solvent (D-1), is a compound having one or more hydroxyl groups in the molecule and publicly known organic solvents can be used without any limitation. These organic solvents can be used alone or in combination. The content of the organic solvent (D-2) is within a range from 1.0 to 40% by weight, preferably from 3.0 to 30% by weight, more preferably from 5.0 to 20% by weight, and most preferably from 7.0 to 15% by weight, based on the resist composition of the present invention. The content is preferably within the above range because a remarkable effect of the present invention is exerted even if the content of the organic solvent (D-1) is low. When the content of the organic solvent (D-2) is less than 1.0% by weight, the dispersion state of the resist composition may be unstable in case of low content of the organic solvent (D-1). On the other hand, even if the content exceeds 40% by weight, an additional effect can not be expected and the amount of the organic solvent increases, and thus merits of the addition of water may be impaired.

(D-2)

Specific examples of the organic solvent (D-2) include methanol, ethanol, 1-propanol, isopropanol, 1-butanol, 1-pentanol, ethylene glycol, propylene glycol, glycerin, 1,2-propanediol, diethylene glycol, triethylene glycol, tetraethylene glycol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, ethylene glycol monoacetate, diethylene glycol monoacetate, triethylene glycol monoacetate, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, propylene glycol monoacetate, and dipropylene glycol monoacetate.

To the resist composition of the present invention, other publicly known organic solvents can also be added, if necessary, and examples thereof include ketones such as acetone, methyl ethyl ketone, and cyclohexanone; aromatic hydrocarbons such as toluene, xylene, ethylbenzene, and tetramethylbenzene; glycol ethers (e.g. ethylene glycol monomethyl ether acetate, ethylene glycol monoethyl ether acetate, ethylene glycol monobutyl ether acetate, propylene glycol monomethyl ether acetate, propylene glycol monoethyl ether acetate, ethylene glycol dimethyl ether, ethylene glycol diethyl ether, ethylene glycol dibutyl ether, diethylene glycol dimethyl ether, diethylene glycol diethyl ether, and diethylene glycol dibutyl ether), acetate esters (e.g. methyl acetate, ethyl acetate, and butyl acetate) and aliphatic hydrocarbons (e.g. octane, decane, and cyclohexane); and petroleum solvents such as petroleum ether, petroleum naphtha, hydrogenated petroleum naphtha, and solvent naphtha.

(E) Polymerizable Monomer

The resist composition of the present invention preferably contains a polymerizable monomer (E), in addition to the above components (A) to (D). The polymerizable monomer (E) is not specifically limited as far as it is a compound which can cause polymerization in the presence of the photopolymerization initiator (B), and publicly known polymerizable monomers can be used alone or in combination.

Examples of the polymerizable monomer (E) include the above-mentioned unsaturated hydroxyl compound, unsaturated epoxy compound, unsaturated carboxylic acid or unsaturated carboxylic anhydride, unsaturated amino compound and unsaturated isocyanate compound, and styrene, vinyltoluene, divinylbenzene, alkyl (meth)acrylate such as methyl methacrylate, allyl ester, (meth)acrylate ester of polyhydric alcohol, and allyl ether of polyhydric alcohol.

Examples of the (meth)acrylate of polyhydric alcohol include ethylene glycol di(meth)acrylate, diethylene glycol di(meth)acrylate, triethylene glycol di(meth)acrylate, polyethylene glycol di(meth)acrylate, trimethylolpropane tri(meth)acrylate, ethoxylated trimethylolpropane tri(meth)acrylate, glycerin tri(meth)acrylate, pentaerythritoltetra (meth)acrylate, and ethoxylated pentaerythritoltetra (meth)acrylate. Examples of the allyl ether of polyhydric alcohol include ethylene glycol diallyl ether, diethylene glycol diallyl ether, diallyl ether, polyethylene glycol diallyl ether, trimethylolpropane triallyl ether, glycerin triallyl ether, and pentaerythritol tetraallyl ether.

(F) Thixotropic Agent

The resist composition of the present invention can also contain a thixotropic agent (F). The thixotropic agent is a compound which can impart thixotropic properties to the resist composition, and publicly known thixotropic agents can be used alone or in combination. The content of the thixotropic agent is commonly within a range from 0.01 to 10.0% by weight, preferably from 0.1 to 5.0% by weight, and more preferably from 0.2 to 2.0% by weight, based on the resist composition. When the content is less than 0.01% by weight, the addition effect is not recognized. On the other hand, when the content exceeds 10% by weight, properties of the coating film may deteriorate because of poor dispersion.

The thixotropic agent is not specifically limited and publicly known thixotropic agents can be used. Examples thereof include inorganic compounds such as calcium stearate, zinc stearate, aluminum stearate, aluminum oxide, zinc oxide, magnesium oxide, glass, diatomaceous earth, titanium oxide, zirconium oxide, silicon dioxide, talc, mica, feldspar, kaolinite (kaolin clay), pyrophyllite (agalmatolite clay), sericite, bentonite, smectites/vermiculites (e.g. montmorillonite, beidellite, nontronite, and saponite), organic bentonite, and organic smectite; and ground organic compounds such as fatty acid amide wax, polyethylene oxide, acrylic resin, amine salt of polymeric polyester, salt of linear polyaminoamide and polymeric polyester, amide solution of polycarboxylic acid, alkyl sulfonate, alkylallyl sulfonate, colloidal ester, polyester resin, phenol resin, melamine resin, epoxy resin, urethane resin, and polyimide resin. These thixotropic agents can be used alone or in combination.

Examples of commercially available inorganic thixotropic agent include Crown Clay, Burgess Clay #60, Burgess Clay KF, and OptiWhite (manufactured by Shiraishi Calcium Kaisha LTD.); Kaolin JP-100, NN Kaolin Clay, ST Kaolin Clay, and Hardsil (manufactured by Tsuchiya Kaolin Ind., Ltd.); ASP-072, Satintonplus, Translink 37, and Hydrousdelami NCD (manufactured by Angel Hard Corporation); SY Kaolin, OS Clay, HA Clay, and MC Hard Clay (manufactured by Maruo Calcium CO., LTD.); Rucentite SWN, Rucentite SAN, Rucentite STN, Rucentite SEN, and Rucentite SPN (manufactred by Corp Chemical); Sumecton (manufactured by Kunimine Industries Co., Ltd.); Bengel, Bengel FW, Esben, Esben 74, Organite, and Organite T (manufactured by Hojun Co.); Hodaka Jirushi, Orben, 250M, Bentone 34, and Bentone 38 (manufactured by Wilbur-Ellis Company); and Laponite, Laponite RD, and Laponite RDS (manufactured by Nippon Silica Industrial Co., Ltd.).

Examples of commercially available organic thixotropic agent include Disparon #6900-20×, Disparon #4200, Disparon KS-873N, and Disparon #1850 (manufactured by Kusumoto Chemicals); BYK-405 and BYK-410 (manufactured by BYC Chemie Japan Co.); Primal RW-12W (manufactured by Rohm&Haas Co.); and A-S-AT-20S, A-S-AT-350F, A-S-AD-10A, and A-S-AD-160 (manufactured by Itoh Oil chemicals Co., Ltd.). These compounds may be dispersed in the solvent.

Among these thixotropic agents, a silicate compound represented by xM(I)₂O.ySiO₂ (also including those corresponding to M(II)O or M(III)₂O₃ wherein oxidation number is 2 or 3, x and y each represent a positive integer) is preferable and a swelling layer clay mineral such as hectorite, bentonite, smectite or vermiculite is more preferable.

Among these thixotropic agents, an amine-modified silicate mineral (organic smectite: obtained by replacing an interlayer cation of sodium by an organic amine compound) can be preferably used and preferred examples thereof include those obtained by replacing a sodium ion of sodium/magnesium silicate (hectorite) by an ammonium ion. Examples of the ammonium ion include monoalkyltrimethylammonium ion having a C6-18 alkyl chain, dialkyldimethylammonium ion, trialkylmethylammonium ion, dipolyoxyethylene coconut oil alkylmethylammonium ion whose oxyethylene chain has 4 to 18 carbon atoms, bis(2-hydroxyethyl) coconut oil alkylmethylammonium ion, and polyoxypropylene methyldiethylammonium ion whose oxopropylene chain has 4 to 25 carbon atoms. These ammonium ions can be used alone or in combination. Examples of commercially available product thereof include Rucentite SAN, Rucentite STN, Rucentite SEN and Rucentite SPN (manufactured by Corp Chemical).

In the photosensitive composition of the present invention, polymerization inhibitors can also be used in combination. As the polymerization inhibitor, conventionally known inhibitors can be used and examples thereof include phenols (e.g. 3,5-ditert-butyl-4-hydroxytoluene), hydroquinones (e.g. hydroquinone, hydroquinonemonomethyl ether) and catechols (e.g. catechol, tert-butylcatechol, and pyrogallol).

In order to improve characteristics such as hardness, publicly known inorganic fillers such as barium sulfate, barium titanate, silicon oxide powder, amorphous silica, magnesium carbonate, calcium carbonate, aluminum oxide, aluminum hydroxide, glass fibers and carbon fibers can be optionally added to the photosensitive composition of the present invention.

Furthermore, there can be optionally added publicly known coloring agents such as acid blue, phthalocyanine blue, phthalocyanine green, iodine green, disazo yellow, crystal violet, titanium oxide, carbon black, and naphthalene black; silicone, fluorine and polymeric defoaming agents and/or leveling agents; and tackifiers such as imidazole, thiazole, triazole and silane coupling agents.

In order to adjust surface tension, surfactants can be added to the resist composition of the present invention. The surfactant is not specifically limited and publicly known surfactants can be used. Examples thereof include anionic surfactants (e.g. sodium dodecylbenzene sulfonate, sodium laurate, and ammonium salt of polyoxyethylene alkyl ether sulfate), nonionic surfactants (e.g. polyoxyethylene alkyl ether, polyoxyethylene alkyl ester, polyoxyethylene sorbitan fatty acid ester, polyoxyethylene alkyl phenyl ether, polyoxyethylene alkylamine, and polyoxyethylene alkylamide) and acetylene glycol surfactants. In the present invention, these surfactants can be used alone or in combination.

The viscosity at 25° C. of the resist composition of the present invention is preferably within a range from 5 to 500 mPa·s, more preferably from 10 to 300 mPa·s, still more preferably from 15 to 200 mPa·s, and most preferably from 20 to 150 mPa·s. When the viscosity is low, thixotropic properties are hardly imparted. On the other hand, when the viscosity is too high, it becomes difficult to adjust the thickness of the coating film during the dip coating. The viscosity is measured by using a commercially available B-type rotary viscometer.

In order to improve safety during storage and transportation, the flash point of the resist composition of the present invention is commonly 40° C. or higher, preferably 55° C. or higher, more preferably 60° C. or higher, and most preferably 70° C. or higher.

The resist composition of the present invention can be produced by mixing the components described above by an arbitrary method, for example, a method of adding the respective components in a container equipped with a stirring blade while stirring. The respective components may be simultaneously added in a container in which the components are mixed, or may be successively added. The respective components may be added at a time, or may be added by plural portions. The temperature upon mixing is not specifically limited and is commonly within a range from 5 to 50° C., and preferably from 10 to 40° C. The mixing operation may be conducted at a given temperature, or may be conducted while varying the temperature.

The resist composition of the present invention can be applied to an arbitrary coating method and is particularly useful for a dip coating method. According to the resist composition of the present invention, it is made possible to suppress a problem of ion crosslinking due to metal ions including copper ions eluted from a copper plate while maintaining sensitivity.

The dip coating method is a publicly known method and a coated substrate is produced by charging a resist composition in a container, dipping an insulating substrate comprising a conductive metal layer such as copper-clad laminate therein, and pulling up at an arbitrary rate. In this case, the temperature of the resist composition in the container can be set to an arbitrary temperature and is preferably within a range from 10 to 50° C.

An apparatus used is not specifically limited and a publicly known apparatus can be used, and the apparatus is preferably an apparatus capable of varying a climbing rate during pulling-up so as to form a uniform film. Examples of commercially available dip coating apparatus include full-automatic dip coater AD-7200, semi-automatic dip coater SD-6200, and five coater SZC-720 (manufactured by SATUMA Communication Industry Co., Ltd.).

A printed circuit board having a prescribed wiring pattern is commonly produced from a copper-clad substrate obtained by the dip coating method through the processes of drying, exposure, development, etching and removal of a resist film and optional other processes.

### EXAMPLES

### Example 1

1) Preparation of Resist Composition

While vigorously stirring of a uniform mixture of the respective components (A) to (F) described below, 41.8 parts by weight of water (C) was added dropwise to the mixture over 15 minutes, followed by stirring for 15 hours. To the resulting solution, 3.0 parts by weight of ethyl lactate (D-1) and 0.3 parts by weight of an aqueous 10 wt % polyvinyl alcohol solution were added, followed by stirring for one hour to prepare a resist composition.

(A) Resin Component

13.8 Parts by weight of a 3,4-epoxy-cyclohexylmethyl acrylate-modified resin of a methacrylic acid-methyl methacrylate copolymer (manufactured by DAICEL CHEMICAL INDUSTRIES, LTD. under the trade name of Cyclomer ACA-200M, acid value: 100 mgKOH/g, weight-average molecular weight: 17,000)

(B) Photopolymerization Initiator

2.4 Parts by weight of 2-methyl-1-(4-methylthiophenyl)-2-morpholinopropan-1-one (D-2)

14.0 Parts by weight of ethylene glycol monobutyl ether and 13.8 parts by weight of propylene glycol monomethyl ether

(E) Polymerizable Monomer

1.4 Parts by weight of an acrylic acid adduct of bisphenol F diglycidyl ether (manufactured by NIPPON KAYAKU CO., LTD. under the trade name of PNA-142) and 5.2 parts by weight of polyethylene glycol diacrylate

(F) Thixotropic Agent

0.7 Parts by weight of a polyoxypropylenemethyldiethylammonium cation-modified product of hectorite

(Other Components)

2.8 Parts by weight of N-methylmorpholine and 0.8 parts by weight of propylene glycol monomethyl ether acetate

2) Evaluation of Storage Stability

After collecting 40 g of the resist composition thus produced in a sealable container, a copper-clad laminate measuring 5 cm×10 cm (manufactured by Matsushita Electric Works. Ltd., comprising a copper foil on both sides) was put in the container and then stored at 40° C. for 7 days. Then, it was confirmed whether or not precipitates were formed in the resist solution and a change in viscosity before and after storage was measured. The results were employed as criterion for evaluation of storage stability upon repeating dip coating.

3) Measurement of Viscosity

The viscosity was measured at 25° C. and 6 rpm by using a B-type viscometer (Model BL, No. 1 rotor) manufactured by TOKI SANGYO CO., LTD.

4) Dip Coating of Resist Composition

The resist composition obtained in (1) was maintained at the temperature of 25° C. and coated on a substrate using a dip coater manufactured by SATUMA Communication Industry Co., Ltd. (trade name: five coater FC-7500). The substrate was dried at 80° C. for 15 minutes to obtain a coated substrate comprising a resist composition coating film having a thickness of about 8 μm. After evaluation of storage stability (2), the resist composition was also dip-coated.

5) Measurement of Sensitivity

The coated substrate (before and after evaluation of storage stability) obtained in (4) was exposed to ultraviolet light (ultra-high pressure mercury lamp, dominant wavelength: 365 nm, 80 mJ/cm²) through a photomask (21-step density tablet, manufactured by Hitachi Chemical Co., Ltd.) and then developed by dipping in an aqueous 1% sodium carbonate solution at 30° C. for 50 seconds.

The above results are shown in Table 1 below.

TABLE 1

| | | | | | Viscosity | | Sensitivity | | |
|---|---|---|---|---|---|---|---|---|---|
| | (D-1) | | (D-2) | | (mPa · s) | | (steps) | | |
| | | Parts by | | Parts by | Before | After | Before | After | |
| | Type | weight | Type | weight | storage | storage | storage | storage | Precipitates |
| Example 1 | Ethyl lactate | 3 | EGB/PGM | 14.0/13.8 | 45 | 45 | 8 | 8 | none |
| Example 2 | Ethyl lactate | 6 | EGB/PGM | 11.0/13.8 | 44 | 45 | 8 | 8 | none |
| Example 3 | Ethyl lactate | 9 | EGB/PGM | 8.0/13.8 | 43 | 44 | 8 | 8 | none |
| Example 4 | Ethyl lactate | 1 | EGB/PGM | 16.0/13.8 | 46 | 48 | 8 | 8 | none |
| Example 5 | Ethyl lactate | 3 | EGB | 27.8 | 48 | 47 | 8 | 8 | none |
| Example 6 | Methyl lactate | 3 | EGB/PGM | 14.0/13.8 | 43 | 44 | 8 | 8 | none |
| Example 7 | Butyl lactate | 3 | EGB/PGM | 14.0/13.8 | 45 | 46 | 8 | 8 | none |
| Example 8 | Butyl lactate | 6 | EGB/PGM | 11.0/13.8 | 45 | 45 | 8 | 8 | none |
| Example 9 | Butyl lactate | 12 | EGB/PGM | 5/13.8 | 46 | 45 | 8 | 8 | none |
| Example 10 | 1,3-propanediol | 3 | EGB/PGM | 14.0/13.8 | 43 | 72 | 8 | 8 | none |
| Example 11 | 2,2-dimethyl-1,3- | 3 | EGB/PGM | 14.0/13.8 | 45 | 63 | 8 | 8 | none |
| | propanediol | | | | | | | | |
| Example 12 | 1,3-butanediol | 3 | EGB/PGM | 14.0/13.8 | 44 | 58 | 8 | 8 | none |
| Example 13 | 3-methoxy-1- | 3 | EGB/PGM | 14.0/13.8 | 42 | 56 | 8 | 8 | none |
| | butanol | | | | | | | | |
| Example 14 | 3-methoxy-1- | 9 | EGB/PGM | 8.0/13.8 | 46 | 52 | 8 | 8 | none |
| | butanol | | | | | | | | |
| Example 15 | 3-methoxy-1- | 12 | EGB/PGM | 5/13.8 | 43 | 49 | 8 | 8 | none |
| | butanol | | | | | | | | |
| Example 16 | 3-methyl-3- | 3 | EGB/PGM | 14.0/13.8 | 47 | 52 | 8 | 8 | none |
| | methoxy-1-butanol | | | | | | | | |
| Example 17 | 3-methyl-3- | 3 | E6B/PGM | 14.0/13.8 | 44 | 53 | 8 | 8 | none |
| | methoxybutyl | | | | | | | | |
| | acetate | | | | | | | | |
| Example 18 | 3-methoxybutyl | 3 | EGB/PGM | 14.0/13.8 | 46 | 61 | 8 | 8 | none |
| | acetate | | | | | | | | |
| Example 19 | Methyl 3- | 3 | EGB/PGM | 14.0/13.8 | 43 | 67 | 8 | 8 | none |
| | methoxypropionate | | | | | | | | |
| Comparative | — | 0 | EGB/PGM | 17.0/13.8 | 46 | 116 | 8 | 8 | formed in |
| Example 1 | | | | | | | | | large amount |
| Comparative | Acetylacetone | 3 | EGB/PGM | 14.0/13.8 | 44 | 40 | 8 | 2 | none |
| Example 2 | | | | | | | | | |
| Comparative | Methyl | 3 | EGB/PGM | 14.0/13.8 | 46 | 120 | 8 | 8 | formed in |
| Example 3 | acetoacetate | | | | | | | | large amount |
| Comparative | Methyl salicylate | 3 | EGB/PGM | 14.0/13.8 | 43 | 113 | 8 | 8 | formed in |
| Example 4 | | | | | | | | | large amount |
| Example 20 | Butyl lactate | 30.8 | — | 0 | 49 | 89 | 8 | 8 | none |
| Example 21 | Butyl lactate | 3 | — | 0 | 41 | 101 | 8 | 8 | formed |

EGB: Ethylene glycol monobutyl ether
PGM: Propylene glycol monomethyl ether

### Examples 2 to 19

In the same manner as in Example 1, except that those described in Table 1 were used as (D-1) and (D-2) in the amounts described in Table 1, resist compositions were produced and evaluated. The results are shown in Table 1.

### Comparative Example 1

In the same manner as in Example 1, except that ethyl lactate was not used and (D-2) EGB was used in the amount described in Table 1, a resist composition was produced and evaluated. The results are shown in Table 1.

### Comparative Examples 2 to 4

In the same manner as in Example 1, except that acetylacetone, methyl acetoacetate and methyl salicylate described in Patent Document 2 (Japanese Examined Patent Publication (Kokoku) No. 6-44150) were used in place of (D-1) ethyl lactate, resist compositions were produced and evaluated. The results are shown in Table 1.

### Example 20

In the same manner as in Example 1, except that all of (D-1) ethyl lactate, (D-2) ethylene glycol monobutyl ether and propylene glycol monomethyl ether were replaced by butyl lactate, a resist composition was produced and evaluated. The results are shown in Table 1.

### Example 21

In the same manner as in Example 1, except that the total amount of (D-2) ethylene glycol monobutyl ether and propylene glycol monomethyl ether was replaced by water, a resist composition was produced and evaluated. The results are shown in Table 1.

As is apparent from the results shown in Table 1, the resist compositions of the present invention do not cause deterioration of sensitivity, increase of viscosity and formation of precipitates due to copper ions eluted from a copper plate as compared with the resist compositions of the prior art.

### EFFECT OF THE INVENTION

The resist composition of the present invention can suppress a problem such as ion crosslinking due to copper ions eluted from a copper plate while maintaining sensitivity, especially in a dip coating method, and contributes to quality stabilization of printed circuit boards and improvement of productivity.

1. A resist composition comprising (A) a resin component, (B) a photopolymerization initiator, (C) water and (D) an organic solvent, wherein the organic solvent (D) contains:
(D-1) at least one organic solvent selected from the group consisting of an α-hydroxycarboxylate ester, a β-alkoxycarboxylate ester, a 1,3-diol compound and a 1,3-diol compound derivative, and
(D-2) an organic solvent having a hydroxyl group other than (D-1).

2. The resist composition according to claim 1, wherein (D-1) is an α-hydroxycarboxylate ester.

3. The resist composition according to claim 2, wherein the α-hydroxycarboxylate ester is a lactate ester.

4. A method of producing a resist-coated substrate, which comprises dipping an insulating substrate comprising a conductive metal in the resist composition according to claim 1.

5. A method of producing a print circuit board, which comprises using the resist composition according to claim 1.

6. A resist composition for dip coating comprising (A) a resin component, (B) a photopolymerization initiator, (C) water and (D) an organic solvent, wherein the organic solvent (D) contains:
(D-1) at least one organic solvent selected from the group consisting of an α-hydroxycarboxylate ester, a β-alkoxycarboxylate ester, a 1,3-diol compound and a 1,3-diol compound derivative.

7. A method of producing a resist-coated substrate, which comprises dipping an insulating substrate comprising a conductive metal in the resist composition according to claim 6.

8. A method of producing a print circuit board, which comprises using the resist composition according to claim 6.

9. A method of producing a resist-coated substrate, which comprises dipping an insulating substrate comprising a conductive metal in the resist composition according to claim 2.

10. A method of producing a print circuit board, which comprises using the resist composition according to claim 2.

11. A method of producing a resist-coated substrate, which comprises dipping an insulating substrate comprising a conductive metal in the resist composition according to claim 3.

12. A method of producing a print circuit board, which comprises using the resist composition according to claim 3.
